(19) United States
(12) Patent Application Publication
(10) Pub. No.: US 2016/0112223 A1
(43) Pub. Date: Apr. 21, 2016

(54) SIGNAL PROCESSING DEVICE

(71) Applicant: MITSUBISHI ELECTRIC CORPORATION, Tokyo (JP)

(72) Inventors: Yusuke KITSUKAWA, Tokyo (JP); Akihito HIRAI, Tokyo (JP); Masanobu HIRAMINE, Tokyo (JP); Hideyuki NAKAMIZO, Tokyo (JP); Kenji KAWAKAMI, Tokyo (JP)

(73) Assignee: MITSUBISHI ELECTRIC CORPORATION, Tokyo (JP)

(21) Appl. No.: 14/786,769

(22) PCT Filed: Mar. 5, 2014
(86) PCT No.: PCT/JP2014/055670

§ 371 Date: Oct. 23, 2015

(30) Foreign Application Priority Data
May 10, 2013 (JP) 2013-100385

(51) Int. Cl. H04L 25/49; H04L 25/08; H04L 7/00

(52) U.S. Cl. CPC H04L 25/4904; H04L 7/0066; H04L 25/08

(57) ABSTRACT

A first clock generation circuit 21 generates a first clock rising at the time which is delayed by αT (0.5<α<1.0) from the transition point of each data of a received signal having a time period of T which is Manchester-encoded. A second clock generation circuit 22 generates a second clock rising at the time which is delayed by βT (0.5<β<1.0) from the transition point, βT being different from αT. A data detection circuit 31 outputs first and second detection results of the received signal on the basis of the first and second clocks, and a determination circuit 41 performs determination on the received signal on the basis of the first and second detection results.

### FIELD OF THE INVENTION

The present invention relates to a signal processing device that is used for a cable or wireless communication device, and that processes a Manchester-encoded received signal.

### BACKGROUND OF THE INVENTION

Conventionally, as a signal processing device that processes a Manchester-encoded received signal, for example, there is provided a device as shown in patent reference 1. This device is provided with a state estimation circuit that estimates a reception state, such as a waveform distortion, from a Manchester-encoded received signal, and a clock reproduction circuit that generates a reproduction clock by using the received signal. Further, a reference which serves as a reference signal of the clock reproduction circuit is prepared in the device, and the device corrects the reference or a sample point on the basis of both the waveform information outputted from the state estimation circuit, and the reproduction clock outputted from the clock reproduction circuit, acquires a correlation between the received signal and the reference from two or more sample points per data, and outputs a determination result on the basis of the correlation value.

### RELATED ART DOCUMENT

### Patent Reference

Patent reference 1: Japanese Unexamined Patent Application Publication No. Hei 11-88447

### SUMMARY OF THE INVENTION

### Problems to be Solved by the Invention

Such a conventional device as mentioned above performs data detection of two or more samples per data, thereby being able to reduce the rate of errors occurring the determination result due to noise, interference, etc. A problem is, however, that because the reference which serves as the reference signal of the clock reproduction circuit is required in order to acquire the information about a plurality of sample points per data, it is difficult to achieve low power consumption.

The present invention is made in order to solve the above-mentioned problem, and it is therefore an object of the present invention to provide a signal processing device that can reduce the error rate of the determination result and can achieve low power consumption.

### Means for Solving the Problem

In accordance with the present invention, there is provided a signal processing device including: a first clock generation circuit to generate a first clock rising at the time which is delayed by αT (0.5<α<1.0) from the transition point of each data of a received signal having a time period of T which is Manchester-encoded; a second clock generation circuit disposed in parallel with the first clock generation circuit to generate a second clock rising at the time which is delayed by βT (0.5<β<1.0), βT being different from αT, from the transition point of each data of the received signal; a data detection circuit to output first and second detection results of the received signal on the basis of the first and second clocks; and a determination circuit to perform determination on the received signal on the basis of the first and second detection results.

### Advantages of the Invention

Because the signal processing device in accordance with the present invention generates two clocks whose edge timings differ from each other without using any reference and performs sampling of the received signal at two different points, the signal processing device can reduce the error rate of the determination result and also achieve low power consumption.

### BRIEF DESCRIPTION OF THE FIGURES

FIG. 1 is a structural diagram showing a signal processing device in accordance with Embodiment 1 of the present invention;

FIG. 2 is an explanatory drawing showing the waveforms of signals in the signal processing device in accordance with Embodiment 1 of the present invention;

FIG. 3 is a structural diagram showing a clock generation circuit provided with a single pulse generation circuit of the signal processing device in accordance with Embodiment 1 of the present invention;

FIG. 4 is an explanatory drawing showing the waveforms of signals in the case of using the clock generation circuits each provided with the single pulse generation circuit of the signal processing device in accordance with Embodiment 1 of the present invention;

FIG. 5 is an explanatory drawing showing the waveforms of signals in a signal processing device in accordance with Embodiment 2 of the present invention;

FIG. 6 is a structural diagram showing a signal processing device in accordance with Embodiment 3 of the present invention;

FIG. 7 is an explanatory drawing showing the waveforms of signals in the signal processing device in accordance with Embodiment 3 of the present invention;

FIG. 8 is an explanatory drawing showing the waveforms of signals in a signal processing device in accordance with Embodiment 4 of the present invention;

FIG. 9 is a structural diagram showing a signal processing device in accordance with Embodiment 5 of the present invention;

FIG. 10 is an explanatory drawing showing the waveforms of signals in the signal processing device in accordance with Embodiment 5 of the present invention;

FIG. 11 is a structural diagram showing a clock generation circuit of a signal processing device in accordance with Embodiment 6 of the present invention; and

FIG. 12 is an explanatory drawing showing the waveforms of signals in the signal processing device in accordance with Embodiment 6 of the present invention.

### EMBODIMENTS OF THE INVENTION

Hereafter, in order to explain this invention in greater detail, the preferred embodiments of the present invention will be described with reference to the accompanying drawings.

### Embodiment 1

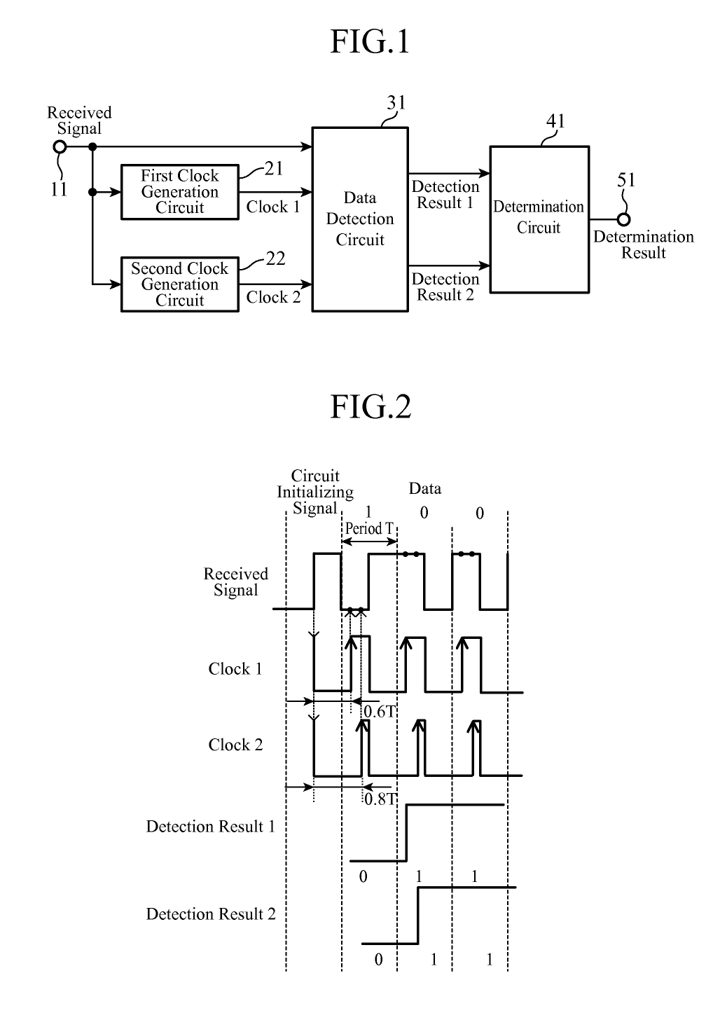

FIG. 1 is a structural diagram of a signal processing device in accordance with Embodiment 1 of the present invention.

Referring to FIG. 1, the signal processing device is provided with an input terminal 11 to receive a Manchester-encoded received signal inputted thereto which consists of data of 0's and 1's, first and second clock generation circuits 21 and 22 to generate a clock 1 (first clock) and a clock 2 (second clock) by using the received signal inputted to the input terminal 11, respectively, a data detection circuit 31 to output detection results 1 and 2 (first and second detection results) on the basis of the clocks 1 and 2 outputted from the first and second clock generation circuits 21 and 22, a determination circuit 41 to output a determination result of the received signal from the detection results 1 and 2, and an output terminal 51 to output the determination result.

The first clock generation circuit 21 generates a clock 1 rising at the time which is delayed by αT (0.5<α<1.0) from the center (in the case of data of “0”, the transition point from 1 to 0, and, in the case of data of “1”, the transition point from 0 to 1) of each data of the received signal having a period of T which is Manchester-encoded with a 50% duty cycle. Although a Manchester code having a 50% duty cycle is used in this embodiment, the duty cycle of the Manchester code can be alternatively other than 50%.

The second clock generation circuit 22 generates a clock 2 rising at the time which is delayed by βT (0.5<β<1.0) from the center of each data of the received signal. The data detection circuit 31 uses the clocks 1 and 2 to sample the received signal at the rising edges of each of the clocks, and outputs detection results 1 and 2.

In this case, by setting α and β for specifying the times when the clocks generated by the first clock generation circuit 21 and the second clock generation circuit 22 rise to different values, the received signal can be sampled at the two points having different timings.

FIG. 2 is an example of the time waveforms of the received signal, the clock 1, the clock 2, the signal of the detection result 1, and the signal of the detection result 2 in a case in which α and β for specifying the times when the clocks rise are set to 0.6 and 0.8, respectively.

In this embodiment, as the received signal having a period of T which is Manchester-encoded with a 50% duty cycle, a circuit initializing signal and 3-bit data (100) are used.

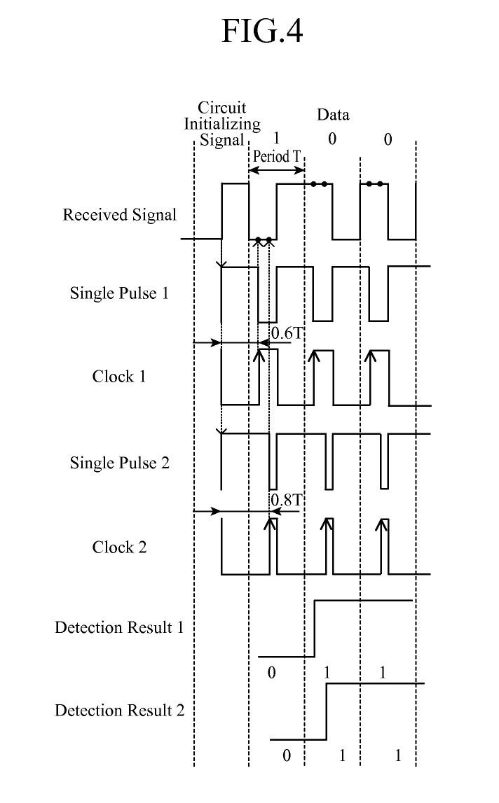

As the clock 1, a clock rising at the time which is delayed by 0.6T from the transition point at the center of each data is generated, and, as the clock 2, a clock rising at the time which is delayed by 0.8T from the transition point at the center of each data is generated. At that time, because the data detection circuit samples the first half of each data of the Manchester code by using the clocks 1 and 2, the data detection circuit outputs “011” which is the inverse of the 3-bit data “100” as the detection results 1 and 2. In the figure, a position shown by each black circle on the received signal shows a sampling point (the same goes for FIGS. 4, 5, 7, 8, 10, and 12 which will be shown).

The determination circuit 41 determines the received signal from the detection results 1 and 2, and outputs a result of the determination from the output terminal 51.

The signal processing device in accordance with Embodiment 1 generates the two clocks whose edge timings differ from each other without using any reference and samples the received signal at two different points in this way, thereby being able to achieve low power consumption and also reduce the error rate of the determination result.

Although in the above-mentioned example, the time when the clock 1 generated by the first clock generation circuit 21 rises is set according to 0.5<α<1.0 and the time when the clock 2 generated by the second clock generation circuit 22 rises is set according to 0.5<β<1.0, the time when the clock 1 generated by the first clock generation circuit 21 rises can be alternatively set according to 0.0<α<0.5 and the time when the clock 2 generated by the second clock generation circuit 22 rises can be alternatively set according to 0.0<β<0.5. Because the data detection circuit samples the second half of the Manchester code by using the clocks 1 and 2 in the case in when the clock generation circuits are configured in this way, the data detection circuit outputs “100” which is the same as the 3-bit data “100” as the detection results 1 and 2.

Also in this case, the determination circuit 41 determines the received signal on the basis of the detection results 1 and 2, and outputs a result of the determination from the output terminal 51. Therefore, the same advantages as those provided by the above-mentioned example can be provided.

Next, as an example of the configuration of each of the first and second clock generation circuits 21 and 22 in accordance with Embodiment 1, a case of using a clock generation circuit provided with a single pulse generation circuit will be explained.

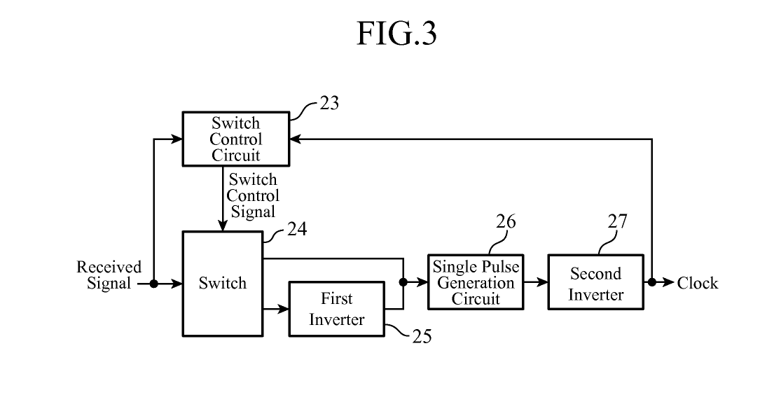

An example of the configuration of the clock generation circuit provided with the single pulse generation circuit is shown in FIG. 3. Referring to FIG. 3, the clock generation circuit is configured with a switch 24 to switch between the output paths of the received signal inputted thereto according to a switch control signal, a first inverter 25 to output a value which is the inverse of a first output of the switch 24, the single pulse generation circuit 26 to output a pulse having a predetermined time width in synchronization with both a second output of the switch 24 and the output from the first inverter 25, a second inverter 27 to output, as a clock, a value which is the inverse of the output of the single pulse generation circuit 26, and a switch control circuit 23 to perform a process of sampling the received signal inputted thereto in synchronization with the clock outputted by the second inverter 27, to generate the switch control signal.

The switch 24 selects an output path according to the switch control signal from the switch control circuit 23.

When the switch control signal from the switch control circuit 23 is “0”, the switch 24 serves as a path connected to the single pulse generation circuit 26, whereas when the switch control signal from the switch control circuit 23 is “1”, the switch 24 serves as a path connected to the first inverter 25.

The first inverter 25 outputs a value which is the inverse of the input value to the single pulse generation circuit 26. The single pulse generation circuit 26 outputs a pulse having a predetermined time width once at each rising edge of the input signal.

The second inverter 27 inverts the output from the single pulse generation circuit 26, and outputs, as a clock, this output inverted thereby to both outside the clock generation circuit, and the switch control circuit 23.

The switch control circuit 23 samples the received signal and outputs a value of “0” or “1” at the time of the sampling to the switch 24, in synchronization with each rising edge of the clock.

According to this configuration, by using a Manchester code as the received signal, a single pulse can be generated in synchronization with the rising or falling edge at the center of each data, and the single pulse inverted can be generated as a clock.

FIG. 4 shows an example of the time waveforms of the received signal, the single pulses 1, the clock 1, the single pulses 2, the clock 2, the signal of the detection result 1, and the signal of the detection result 2 in the case of using the clock generation circuits each equipped with the single pulse generation circuit.

In this case, a circuit initializing signal and 3-bit data (100) which are a Manchester code having a period of T and a 50% duty cycle are used as the received signal, and the pulse width α=0.6 and the pulse width β=0.8. Further, an initial state of the switch control circuit 23 is “0.”

Because the output of the switch control circuit 23 is “0” at the center of the data of the circuit initializing signal in the example of FIG. 4, the clock generation circuits generate a single pulse 1 having a pulse width of 0.6T and a single pulse 2 having a pulse width of 0.8T at the time of the rising edge (a data transition point from 0 to 1). The clock generation circuits invert the single pulse 1 and the single pulse 2 generated thereby by using the second inverters 27, and output the clocks 1 and 2, respectively. At that time, the data detection circuit samples the first half of the first data “1” of the three bits of the received signal by using the clocks 1 and 2, and outputs the sampled results as the detection results 1 and 2.

Next, because the output of the switch control circuit 23 is “0” at the center of the first data “1” of the three bits, the clock generation circuits generate a single pulse 1 having a pulse width of 0.6T and a single pulse 2 having a pulse width of 0.8T at the time of the rising edge, and the data detection circuit samples the first half of the second data “0” of the three bits of the received signal by using the clocks 1 and 2 and outputs the sampled results as the detection results 1 and 2 in the same way as that mentioned above. At that time, because the sampled value is “1”, the output of the switch control circuit 23 changes from “0” to “1.”

After that, because the output of the switch control circuit 23 is “1” at the center of the second data “0” of the three bits, the output of the switch 24 switches to the path connected to the first inverter 25. At that time, the falling edge which is at the center of the received signal of “0” (a data transition point from 1 to 0) is inverted by the first inverter 25 and a rising signal is inputted to the single pulse generation circuit 26, and the clock generation circuits generate a single pulse 1 having a pulse width of 0.6T and a single pulse 2 having a pulse width of 0.8T at the time of the rising edge to generate clocks in the same way as that mentioned above. The data detection circuit samples the first half of the third data “0” of the three bits of the received signal by using the generated clocks, and outputs the sampled results as the detection results 1 and 2.

As mentioned above, the clock generation circuits generate a single pulse 1 having a pulse width of 0.6T and a single pulse 2 having a pulse width of 0.8T at the time of the rising or falling edge at the center of each data, and invert the generated pulses and output the pulses inverted thereby as the clocks, and the data detection circuit can sample two different points of each data signal by using the outputted clocks.

Further, although in Embodiment 1 the case of using the two clock generation circuits is explained, an improvement effect is acquired similarly even in a case of using three or more clock generation circuits. In this case, at least one of the first clock and the second clock is a plurality of clocks.

As previously explained, because the signal processing device in accordance with Embodiment 1 includes: the first clock generation circuit to generate a first clock rising at the time which is delayed by αT (0.5<α<1.0) from the transition point of each data of a Manchester-encoded received signal having a period of T; the second clock generation circuit to generate a second clock rising at the time which is delayed by βT (0.5<β<1.0), βT being different from αT, from the transition point of each data of the received signal; the data detection circuit to output first and second detection results of the received signal on the basis of the first and second clocks; and the determination circuit to perform determination on the received signal on the basis of the first and second detection results, the error rate of the determination result can be reduced and low power consumption can also be achieved.

As an alternative, because the signal processing device in accordance with Embodiment 1 includes: the first clock generation circuit to generate a first clock rising at the time which is delayed by αT (0<α<0.5) from the transition point of each data of a Manchester-encoded received signal having a period of T; the second clock generation circuit to generate a second clock rising at the time which is delayed by βT (0<β<0.5), βT being different from αT, from the transition point of each data of the received signal; the data detection circuit to output first and second detection results of the received signal on the basis of the first and second clocks; and the determination circuit to perform determination on the received signal on the basis of the first and second detection results, the error rate of the determination result can be reduced and low power consumption can also be achieved.

### Embodiment 2

A signal processing device in accordance with Embodiment 2 is configured in such a way that the times when a first clock generation circuit 21 and a second clock generation circuit 22 generate clocks differ from those in Embodiment 1, and has a configuration in terms of drawings which is the same as that shown in FIG. 1. Therefore, an explanation will be made by using the configuration shown in FIG. 1.

More specifically, the first clock generation circuit 21 in accordance with Embodiment 2 generates a first clock rising at the time which is delayed by αT (0.5<α<1.0) from the transition point of each data of a received signal having a period of T which is Manchester-encoded with a 50% duty cycle. Further, the second clock generation circuit 22 generates a second clock rising at the time which is delayed by βT (0<β<0.5) from the transition point of each data of the received signal. Because the other components other than these clock generation circuits are the same as those in accordance with Embodiment 1, the explanation of the other components will be omitted hereafter.

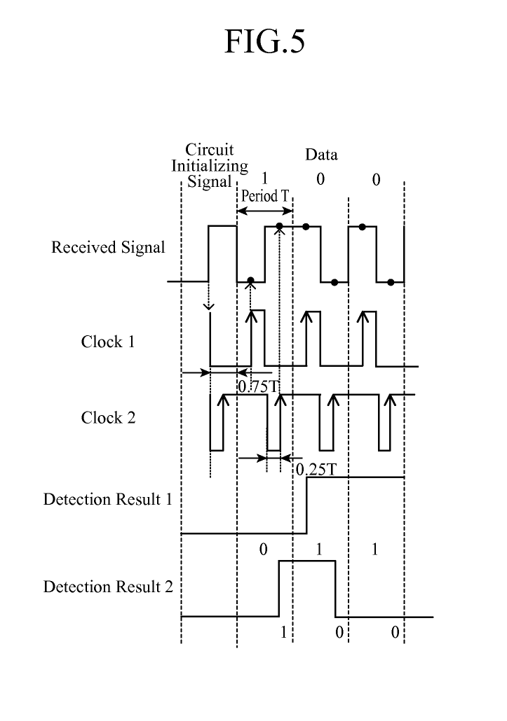

FIG. 5 is a diagram showing an example of the time waveforms of signals in the signal processing device in accordance with Embodiment 2. This example differs from the first example shown in Embodiment 1 in that the time when the clock is generated by the second clock generation circuit 22 in accordance with Embodiment 2 is set according to 0.0<β<0.5.

In this embodiment, by setting the time when the clock 1 is generated by the first clock generation circuit 21 according to 0.5<α<1.0, and also setting the time when the clock 2 is generated by the second clock generation circuit 22 according to 0.0<β<0.5, the clock 1 enables the first half of the Manchester code to be sampled and the clock 2 enables the second half of the Manchester code to be sampled.

FIG. 5 shows an example of the time waveforms of the received signal, the clock 1, the clock 2, the signal of a detection result 1, and the signal of a detection result 2 in a case in which α and β are set to 0.75 and 0.25, respectively, in Embodiment 2.

A circuit initializing signal and 3-bit data (100) which use a Manchester code having a 50% duty cycle are used as the received signal, like in the case shown in FIG. 2.

As the clock 1, a clock rising at the time which is delayed by 0.75T from the transition point at the center of each data is generated, and, as the clock 2, a clock rising at the time which is delayed by 0.25T from the transition point at the center of each data is generated.

At that time, because a data detection circuit samples the first half of the Manchester code by using the clock 1, the data detection circuit outputs “011” which is the inverse of the 3-bit data “100” as the detection result 1. On the other hand, because the data detection circuit samples the second half of the Manchester code by using the clock 2, the data detection circuit outputs “100” which is the same as the 3-bit data “100” as the detection result 2.

A determination circuit 41 determines the received signal on the basis of the detection results 1 and 2, and outputs a result of the determination from an output terminal 51.

The signal processing device in accordance with Embodiment 2 generates the two clocks whose edge timings differ from each other without using any reference and samples the two points in the first and second halves of the Manchester-encoded received signal in this way, thereby being able to achieve low power consumption and also reduce the error rate of the determination result.

Further, although also in Embodiment 2 the case of using the two clock generation circuits is explained, an improvement effect is acquired similarly even in a case of using three or more clock generation circuits.

As previously explained, because the signal processing device in accordance with Embodiment 2 includes: the first clock generation circuit to generate a first clock rising at the time which is delayed by αT (0.5<α<1.0) from the transition point of each data of a Manchester-encoded received signal having a period of T; the second clock generation circuit to generate a second clock rising at the time which is delayed by βT (0<β<0.5) from the transition point of each data of the received signal; the data detection circuit to output first and second detection results of the received signal on the basis of the first and second clocks; and the determination circuit to perform determination on the received signal on the basis of the first and second detection results, the error rate of the determination result can be reduced and low power consumption can also be achieved.

### Embodiment 3

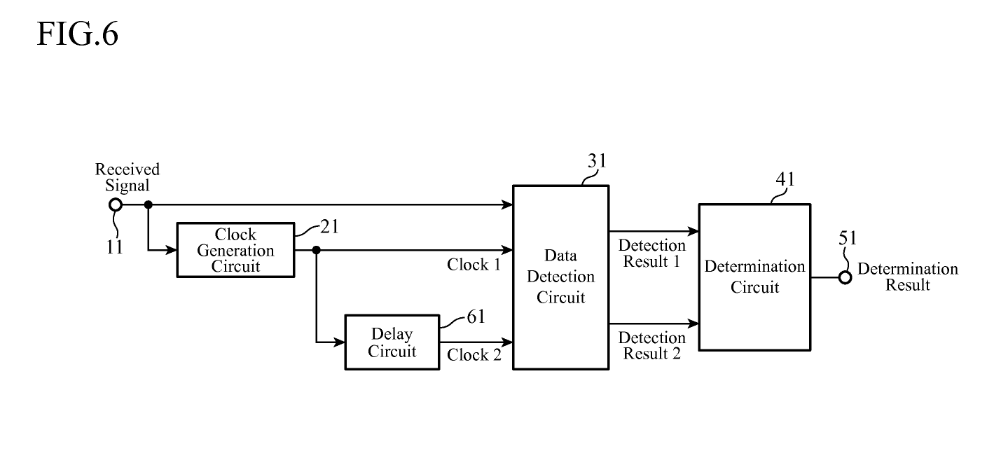

FIG. 6 is a structural diagram of a signal processing device in accordance with Embodiment 3 of the present invention.

Referring to FIG. 6, the signal processing device is provided with an input terminal 11 to receive a Manchester-encoded received signal inputted thereto, a clock generation circuit 21 to generate a clock by using the received signal, a delay circuit 61 to provide a delay for the clock 1 outputted from the clock generation circuit 21, a data detection circuit 31 to output detection results 1 and 2 on the basis of both the clock 1 outputted from the clock generation circuit 21 and a clock 2 generated by the delay circuit 61, a determination circuit 41 to output a determination result from the detection results 1 and 2, and an output terminal 51 to output the determination result.

The clock generation circuit 21 generates a clock 1 rising at the time when is delayed by αT (0.5<α<1.0) from the center of each data of the received signal. The delay circuit 61 provides the predetermined delay time γT (0<γ<1.0−α) for the clock 1 outputted from the clock generation circuit 21. By generating a clock in which the delay time is provided for the clock 1 outputted from the clock generation circuit 21 by using the delay circuit 61, the received signal can be sampled at two different points. Therefore, there can be provided the same advantages as those provided by Embodiment 1 by simply using the single clock generation circuit.

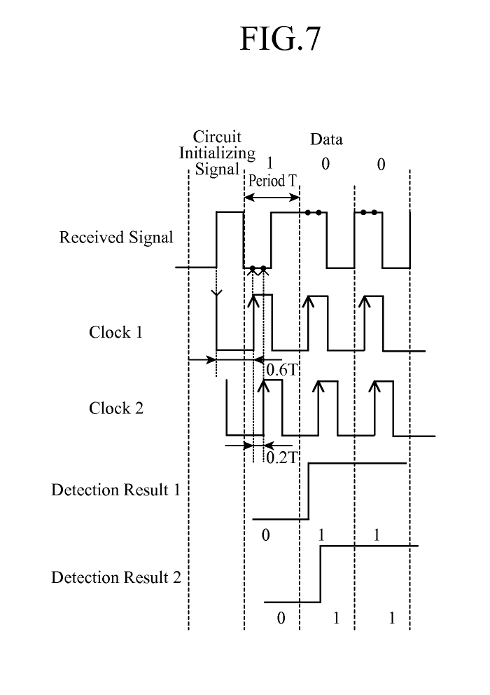

FIG. 7 shows an example of the time waveforms of the received signal, the clock 1, the clock 2, the signal of the detection result 1, and the signal of the detection result 2 in the signal processing device in accordance with Embodiment 3.

In this embodiment, a circuit initializing signal and 3-bit data (100) which use a Manchester code having a 50% duty cycle are used as the received signal, and the period of the received signal is T, the time which the clock rise is set according to α=0.6, and the delay time is set according to γ=0.2.

The clock generation circuit 21 generates a clock 1 rising at the time which is delayed by 0.6T from the transition point at the center of each data. The delay circuit 61 provides the delay of 0.2T for the clock 1, thereby causing the clock 2 to rise at a time different from that when the clock 1 rises.

At that time, because the data detection circuit samples the first half of the Manchester code by using the clocks 1 and 2, the data detection circuit outputs “011” which is the inverse of the 3-bit data“100” as the detection results 1 and 2.

The determination circuit 41 determines the received signal on the basis of the detection results 1 and 2, and outputs a result of the determination from the output terminal 51.

The signal processing device in accordance with Embodiment 3 generates the two clocks whose edge timings differ from each other without using any reference and samples the received signal at two points having different timings in this way, thereby being able to achieve low power consumption and also reduce the error rate of the determination result.

Although in the above-mentioned example the time when the clock 1 rises is set according to 0.5<α<1.0 and the time when the clock 2 rises is set according to 0<γ<1.0−α, the rising time αT set in the clock generation circuit 21 and the delay time γT set in the delay circuit 61 can be alternatively set according to 0.0<α<0.5 and 0<γ<0.5−α, respectively. In this case, because the data detection circuit samples the second half of the Manchester code by using the clocks 1 and 2, the data detection circuit outputs “100” which is the same as the 3-bit data “100” as the detection results 1 and 2.

Also in this case, the determination circuit 41 determines the received signal on the basis of the detection results 1 and 2, and outputs a result of the determination from the output terminal 51. Therefore, even if the signal processing device has such a configuration as above, the signal processing device can provide the same advantages.

Further, by using the clock generation circuit shown in FIG. 3 as the clock generation circuit 21 in accordance with Embodiment 3, the same advantages as those provided by Embodiment 1 are provided.

Although the example of generating a clock by using the single delay circuit is explained by using FIG. 6, even in a case of generating two or more clocks by using two or more delay circuits, the same advantages are provided. More specifically, in this case, a plurality of second clocks are generated.

As previously explained, the signal processing device in accordance with Embodiment 3 includes: the clock generation circuit to generate a first clock rising at the time which is delayed by αT (0.5<α<1.0) from the transition point of each data of a Manchester-encoded received signal having a period of T; the delay circuit to provide a delay time γT (0<γ<1.0−α) for the first clock generated by the clock generation circuit, to generate a second clock; the data detection circuit to output first and second detection results of the received signal on the basis of the first and second clocks; and the determination circuit to perform determination on the received signal on the basis of the first and second detection results, the error rate of the determination result can be reduced and low power consumption can also be achieved.

Further, the signal processing device in accordance with Embodiment 3 includes: the clock generation circuit to generate a first clock rising at the time which is delayed by αT (0<α<0.5) from the transition point of each data of a Manchester-encoded received signal having a period of T; the delay circuit to provide a delay time γT (0<γ<0.5−α) for the first clock generated by the clock generation circuit, to generate a second clock; the data detection circuit to output first and second detection results of the received signal on the basis of the first and second clocks; and the determination circuit to perform determination on the received signal on the basis of the first and second detection results, the error rate of the determination result can be reduced and low power consumption can also be achieved.

### Embodiment 4

A signal processing device in accordance with Embodiment 4 is configured in such away that a delay time γT set in a delay circuit 61 in accordance with Embodiment 4 differs from that in Embodiment 3, and has a configuration in terms of drawings which is the same as that shown in FIG. 6. Therefore, an explanation will be made by using the configuration shown in FIG. 6.

More specifically, the delay circuit 61 in accordance with Embodiment 4 provides a delay time γT (1.0−α<γ<1.5−α) for a first clock generated by a clock generation circuit, to generate a second clock. Because the other components other than this delay circuit are the same as those in accordance with Embodiment 3, the explanation of the other components will be omitted hereafter.

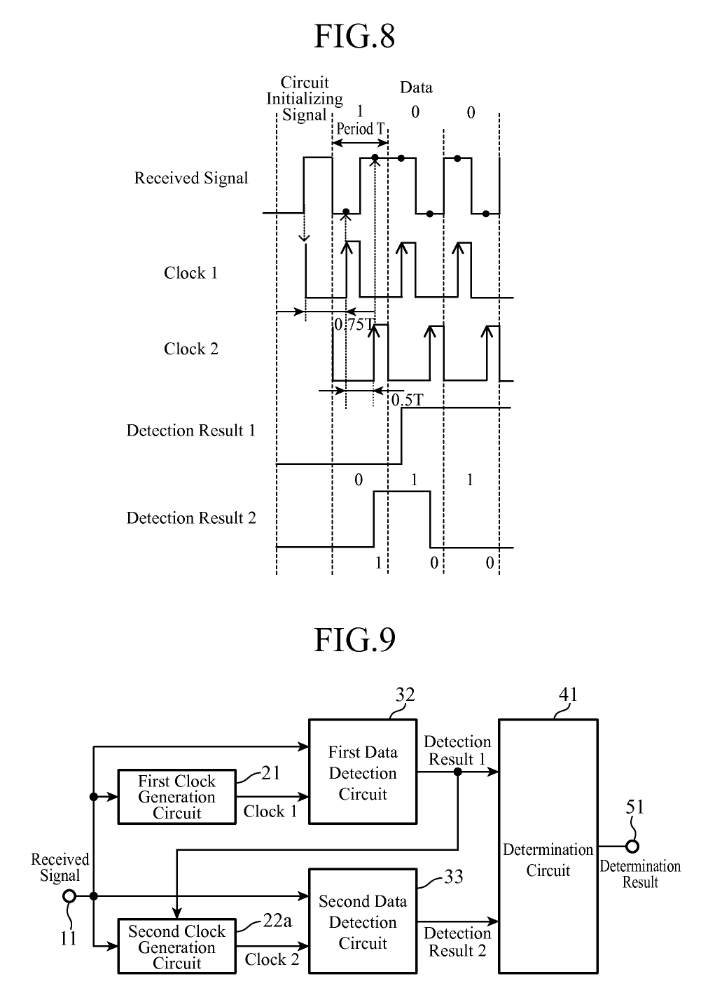

FIG. 8 is a diagram showing an example of the time waveforms of signals in the signal processing device in accordance with Embodiment 4. This example differs from that shown in Embodiment 3 in that the delay time γT set in the delay circuit 61 in accordance with Embodiment 3 is set according to 1.0−α<γ<1.5−α.

In this embodiment, by setting the time when the clock 1 is generated by the clock generation circuit 21 according to 0.5<α<1.0 and also setting the delay time γT set in the delay circuit 61 according to 1.0−α<γ<1.5−α, a data detection circuit can sample the first half of the Manchester code by using the clock 1, and sample the second half of the Manchester code by using the clock 2.

FIG. 8 shows an example of the time waveforms of the received signal, the clock 1, the clock 2, the signal of a detection result 1, and the signal of a detection result 2 in a case in which αand γ are set to 0.75 and 0.5, respectively, in Embodiment 4.

A circuit initializing signal and 3-bit data (100) which use a Manchester code having a 50% duty cycle are used as the received signal, like in the case shown in FIG. 2 of Embodiment 3.

Because the clock generation circuit generates a clock 1 at the time which is delayed by 0.75T from the transition point at the center of each data and the data detection circuit samples the first half of the Manchester code, the data detection circuit outputs “011” which is the inverse of the 3-bit data “100” as the detection result 1. On the other hand, because the clock 2 is delayed by 1T to 0.5T from the clock 1 and the data detection circuit samples the second half of the Manchester code, the data detection circuit outputs “100” which is the same as the 3-bit data“100” as the detection result 2.

A determination circuit 41 determines the received signal on the basis of the detection results 1 and 2, and outputs a result of the determination from an output terminal 51.

The signal processing device in accordance with Embodiment 4 generates the two clocks whose edge timings differ from each other without using any reference and samples the two points in the first and second halves of the Manchester-encoded received signal in this way, thereby being able to achieve low power consumption and also reduce the error rate of the determination result.

Although in the above-mentioned example the time when the clock 1 rises is set according to 0.5<α<1.0, the rising time αT set in the clock generation circuit 21 can be alternatively set according to 0.0<α<0.5. In the case in which the clock generation circuit is configured in this way, because the data detection circuit samples the second half of the Manchester code by using the clock 1, the data detection circuit outputs “100” which is the same as the 3-bit data “100” as the detection result. On the other hand, because the data detection circuit samples the second half of the Manchester code by using the clock 2, the data detection circuit outputs “011” which is the inverse of the 3-bit data“100” as the detection result 2.

Also in this case, the determination circuit 41 determines the received signal on the basis of the detection results 1 and 2, and outputs a result of the determination from the output terminal 51. Therefore, even if the signal processing device has such a configuration as above, the signal processing device can provide the same advantages.

Although also in Embodiment 4 the case of using the single delay circuit 61 is explained, an improvement effect is acquired similarly even in a case of using two or more delay circuits.

As previously explained, the signal processing device in accordance with Embodiment 4 includes: the clock generation circuit to generate a first clock rising at the time which is delayed by αT (0.5<α<1.0) from the transition point of each data of a received signal having a period of T which is Manchester-encoded with a 50% duty cycle; the delay circuit to provide a delay time γT (1.0−α<γ<1.5−α) for the first clock generated by the clock generation circuit, to generate a second clock; the data detection circuit to output first and second detection results of the received signal on the basis of the first and second clocks; and the determination circuit to perform determination on the received signal on the basis of the first and second detection results, the error rate of the determination result can be reduced and low power consumption can also be achieved.

Further, the signal processing device in accordance with Embodiment 3 includes: the clock generation circuit to generate a first clock rising at the time which is delayed by αT (0<α<0.5) from the transition point of each data of a Manchester-encoded received signal having a period of T; the delay circuit to provide a delay time γT (1.0−α<γ<1.5−α) for the first clock generated by the clock generation circuit, to generate a second clock; the data detection circuit to output first and second detection results of the received signal on the basis of the first and second clocks; and the determination circuit to perform determination on the received signal on the basis of the first and second detection results, the error rate of the determination result can be reduced and low power consumption can also be achieved.

### Embodiment 5

FIG. 9 is a structural diagram of a signal processing device in accordance with Embodiment 5 of the present invention.

Referring to FIG. 9, the signal processing device is provided with an input terminal 11 to receive a Manchester-encoded received signal inputted thereto, a first clock generation circuit 21 to generate a clock 1 by using the received signal, a first data detection circuit 32 to output a detection result 1 on the basis of the clock 1 outputted from the first clock generation circuit 21, a second clock generation circuit 22a to generate a clock 2 by using the received signal and the detection result 1, a second data detection circuit 33 to output a detection result 2 on the basis of the clock 2 outputted from the second clock generation circuit 22a, a determination circuit 41 to output a determination result from the detection results 1 and 2, and an output terminal 51 to output the determination result acquired by the determination circuit 41.

The first clock generation circuit 21 generates a clock 1 rising at the time which is delayed by αT (0.5<α<1.0) from the center (in the case of data of “0”, the transition point from 1 to 0, and, in the case of data of “1”, the transition point from 0 to 1) of each data of a received signal. The second clock generation circuit 22a generates a clock 2 rising at the time which is delayed by βT (0.0<β<0.5) from the center of each data of the received signal according to the detection result 1 from the first data detection circuit 32. At that time, because the clock 1 generated by the first clock generation circuit 21 rises in the first half of each data, and the clock 2 generated by the second clock generation circuit 22a rises in the second half of each data, the received signal can be sampled at two different points.

The details of the second clock generation circuit 22a will be explained in Embodiment 6.

Further, in this embodiment, while the first clock generation circuit 21 needs to detect the transition point at the center of each data of the received signal to determine whether or not to generate a clock at the rising or falling edge, the second clock generation circuit 22a does not have to perform this process.

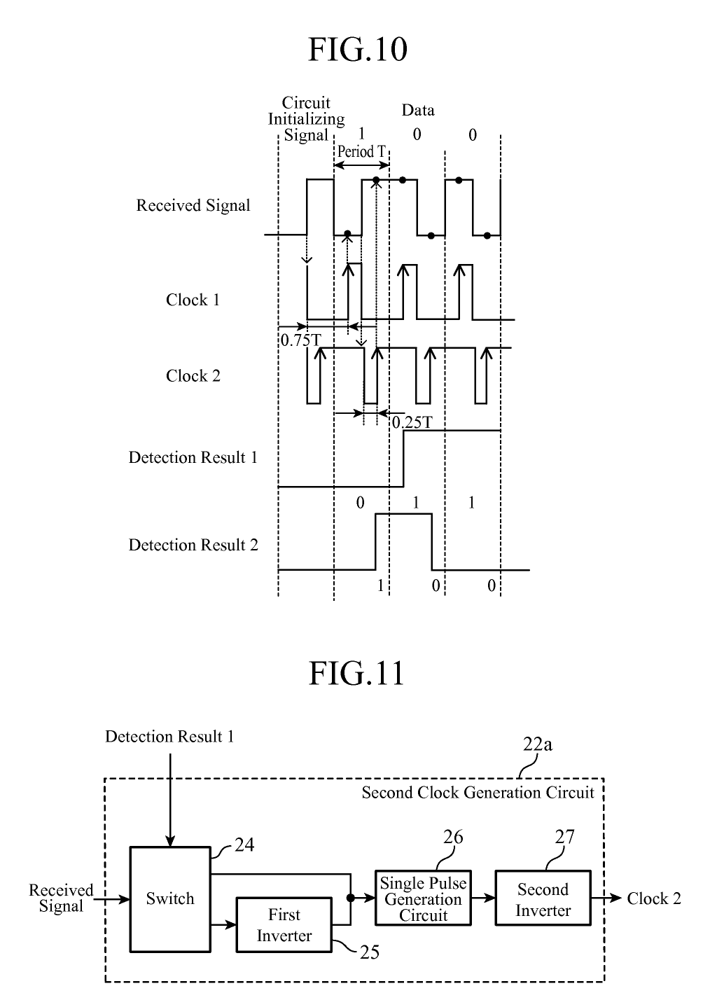

FIG. 10 shows an example of the time waveforms of the received signal, the clock 1, and the clock 2 in the signal processing device in accordance with Embodiment 5.

In this embodiment, a circuit initializing signal and 3-bit data (100) which use a Manchester code are used as the received signal, and the period of the received signal is T and the times which the clocks rise are set according to α=0.75 and β=0.25.

As the clock 1, a clock rising at the time which is delayed by 0.75T from the transition point at the center of each data is generated, and, as the clock 2, a clock rising at the time which is delayed by 0.25T from the transition point at the center of each data is generated. At that time, because the first data detection circuit samples the first half of each data of the Manchester code by using the clock 1, the first data detection circuit outputs “011” which is the inverse of the 3-bit data “100” as the detection result 1, while because the second data detection circuit samples the second half of each data of the Manchester code by using the clock 2, the second data detection circuit outputs “100” which is the same as the 3-bit data “100” as the detection result 2.

The determination circuit 41 determines the received signal on the basis of the detection results 1 and 2, and outputs a result of the determination from the output terminal 51.

The signal processing device in accordance with Embodiment 5 generates the two clocks whose edge timings differ from each other without using any reference and samples the two points in the first and second halves of the Manchester-encoded received signal in this way, thereby being able to achieve low power consumption and also reduce the error rate of the determination result.

As previously explained, because the signal processing device in accordance with Embodiment 5 of the present invention includes: the first clock generation circuit to generate a first clock rising at the time which is delayed by αT (0.5<α<1.0) from the transition point of each data of a Manchester-encoded received signal; the first data detection circuit to output a first detection result of the received signal on the basis of the first clock; the second clock generation circuit to generate a second clock rising at the time which is delayed by βT (0<β<0.5) from the transition point of each data of the received signal by using the first detection result; the second data detection circuit to output a second detection result of the received signal on the basis of the second clock; and the determination circuit to perform determination on the received signal on the basis of the first and second detection results, the error rate of the determination result can be reduced and low power consumption can also be achieved.

### Embodiment 6

Embodiment 6 is an example of using the clock generation circuit shown in FIG. 3 as the first clock generation circuit 21 in Embodiment 5 and also using the clock generation circuit shown in FIG. 11 as a second clock generation circuit 22a.

The second clock generation circuit 22a shown in FIG. 11 is configured in such away that, instead of the switch control signal from the switch control circuit 23 in the clock generation circuit shown in FIG. 3, a detection result 1 outputted from a first data detection circuit 32 is inputted to a switch 24. Because the other components are the same as those shown in FIG. 3, the corresponding components are denoted by the same reference numerals and the explanation of the components will be omitted hereafter.

The first clock generation circuit 21 is provided with a single pulse generation circuit 26 to generate a single pulse 1 having a pulse width of αT (0.5<α<1.0) in the clock generation circuit shown in FIG. 3.

The second clock generation circuit 22a includes a switch 24 to switch between paths according to the detection result 1, and a single pulse generation circuit 26 to generate a single pulse 2 having a pulse width of βT (0.0<β<0.5).

In this case, the clock generation circuit shown in FIGS. 3 and 11 uses a Manchester code as a received signal, thereby generating a single pulse 1 or 2 in synchronization with the rising or falling edge at the center of each data of the received signal, inverts the generated pulse, and outputs this pulse as a clock 1 or 2.

At that time, because the clock 1 generated by the first clock generation circuit 21 rises in the first half of each data of the received signal, and the clock 2 generated by the second clock generation circuit 22a rises in the second half of each data of the received signal, the signal processing device can sample the received signal at two points having different timings.

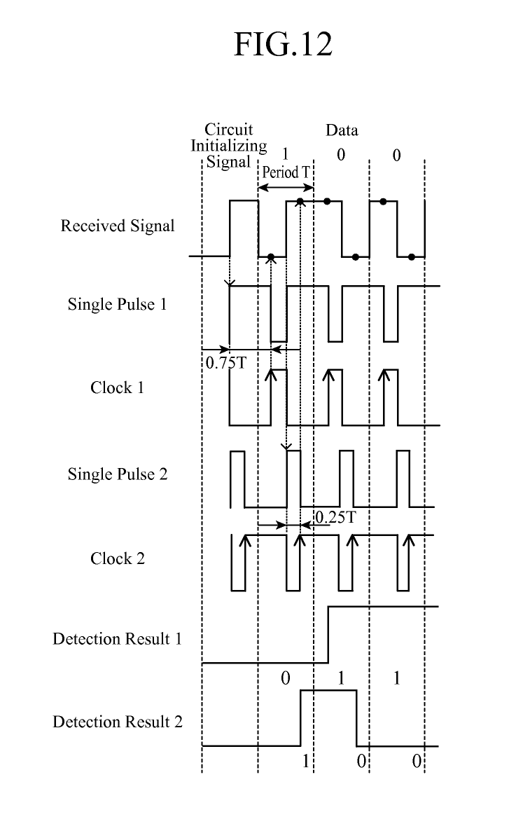

FIG. 12 is an example of the time waveforms of the received signal, the single pulses 1, the clock 1, the single pulses 2, the clock 2, the signal of the detection result 1, and the signal of the detection result 2 in the signal processing device in accordance with Embodiment 6.

In this embodiment, a circuit initializing signal and 3-bit data (100) which use a Manchester code having a 50% duty cycle are used as the received signal, the period of the received signal is T and the pulse width α=0.75 and the pulse width β=0.25.

The first clock generation circuit generates a single pulse 1 having a pulse width of 0.75T at the time of the rising or falling edge at the center of each data, inverts the generated pulse, and outputs this pulse as the clock 1. The signal processing device acquires the detection result 1 by using the outputted clock 1.

When the detection result 1 is “0”, the second clock generation circuit generates a single pulse 2 having a width of 0.25T at the rising edge of the received signal, whereas when the detection result 1 is “1”, the second clock generation circuit generates a single pulse 2 having a width of 0.25T at the falling edge of the received signal, and inverts the generated pulse and outputs this pulse as the clock 2. The signal processing device acquires the detection result 2 by using the outputted clock 2.

The signal processing device in accordance with Embodiment 6 generates the two clocks whose edge timings differ from each other without using any reference and samples the two points in the first and second halves of the Manchester-encoded received signal in this way, thereby being able to achieve low power consumption and also reduce the error rate of the determination result.

As previously explained, because in the signal processing device in accordance with Embodiment 6, the second clock generation circuit includes: the switch to switch the output path of a received signal inputted thereto between a first output and a second output according to a first detection result; the first inverter connected to the first output of the switch; the single pulse generation circuit to output a pulse having a predetermined time width in synchronization with both the second output of the switch and an output from the first inverter; and the second inverter to output, as a second clock, a value which is the inverse of the output of the single pulse generation circuit, the second clock generation circuit for implementing the effect of the signal processing device in accordance with Embodiment 5 can be provided.

While the invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

Because the signal processing device in accordance with the present invention generates two clocks whose edge timings differ from each other without using any reference, and samples a received signal at two different points, thereby being able to reduce the error rate of the determination result and achieve low power consumption, the signal processing device is suitable for use in cable or wireless communication devices, and so on.

### Explanations of Reference Numerals

11 input terminal, 21 first clock generation circuit, 22 and 22a second clock generation circuit, 23 switch control circuit, 24 switch, 25 first inverter, 26 single pulse generation circuit, 27 second inverter, 31 data detection circuit, 32 first data detection circuit, 33 second data detection circuit, 41 determination circuit, 51 output terminal, and 61 delay circuit.

1. A signal processing device comprising:
a first clock generation circuit to generate a first clock rising at a time which is delayed by αT (0.5<α<1.0) from a transition point of each data of a received signal having a time period of T which is Manchester-encoded;
a second clock generation circuit disposed in parallel with said first clock generation circuit, to generate a second clock rising at a time which is delayed by βT (0.5<β<1.0), βT being different from said αT, from the transition point of each data of said received signal;
a data detection circuit to output first and second detection results of said received signal on a basis of said first and second clocks; and
a determination circuit to perform determination on the received signal on a basis of said first and second detection results.

2. A signal processing device comprising:
a first clock generation circuit to generate a first clock rising at a time which is delayed by αT (0<α<0.5) from a transition point of each data of a received signal having a time period of T which is Manchester-encoded;
a second clock generation circuit disposed in parallel with said first clock generation circuit, to generate a second clock rising at a time which is delayed by βT (0<β<0.5), βT being different from said αT, from the transition point of each data of said received signal;
a data detection circuit to output first and second detection results of said received signal on a basis of said first and second clocks; and
a determination circuit to perform determination on the received signal on a basis of said first and second detection results.

3. A signal processing device comprising:
a first clock generation circuit to generate a first clock rising at a time which is delayed by αT (0.5<α<1.0) from a transition point of each data of a received signal having a time period of T which is Manchester-encoded;
a second clock generation circuit disposed in parallel with said first clock generation circuit, to generate a second clock rising at a time which is delayed by βT (0<β<0.5) from the transition point of each data of said received signal;
a data detection circuit to output first and second detection results of said received signal on a basis of said first and second clocks; and
a determination circuit to perform determination on the received signal on a basis of said first and second detection results.

4. (canceled)

5. (canceled)

6. (canceled)

7. (canceled)

8. The signal processing device according to claim 3, wherein said data detection circuit includes
a first data detection circuit and a second data detection circuit, said first data detection circuit outputting a first detection result of said received signal on a basis of said first clock, wherein
said second clock generation circuit generates said second clock by using said first detection result, and
said second data detection circuit outputs a second detection result of said received signal on a basis of said second clock.

9. The signal processing device according to claim 8, wherein said second clock generation circuit includes: a switch to switch an output path of the received signal inputted thereto between a first output and a second output according to said first detection result; a first inverter connected to said first output of said switch; a single pulse generation circuit to output a pulse having a predetermined time width in synchronization with both said second output of said switch and an output from said first inverter; and a second inverter to output, as said second clock, a value which is inverse of the output of said single pulse generation circuit.
